(19) United States
(12) Patent Application Publication
(10) Pub. No.: US 2026/0178955 A1
(43) Pub. Date: Jun. 25, 2026

(54) QUANTUM COMPUTING CIRCUIT AND COUPLER

(71) Applicant: NEC Corporation, Tokyo (JP)

(72) Inventor: Yohei KAWAKAMI, Tokyo (JP)

(73) Assignee: NEC Corporation, Tokyo (JP)

(21) Appl. No.: 19/401,774

(22) Filed: Nov. 26, 2025

(30) Foreign Application Priority Data
Dec. 23, 2024 (JP) 2024-226517

(51) Int. Cl. G06N 10/40; G06N 10/20

(52) U.S. Cl. CPC G06N 10/40; G06N 10/20

(57) ABSTRACT

A quantum computing circuit includes quantum bit elements, and a coupler that causes equal to or more than two of the quantum bit elements to interact with each other, wherein the coupler includes a loop including a plurality of Josephson junctions, at least two of the Josephson junctions having different critical current values, and a magnetic field applying means for applying a magnetic field to the loop.

This application is based upon and claims the benefit of priority from Japanese Patent Application No. 2024-226517, filed on Dec. 23, 2024, the disclosure of which is incorporated herein in its entirety by reference.

### TECHNICAL FIELD

The present disclosure relates to a quantum computing circuit and a coupler.

### BACKGROUND ART

In a configuration in which a plurality of quantum bit elements are coupled, the interaction strength between the plurality of quantum bit elements (the coupling strength of the quantum bit elements) may be adjusted.

For example, JP 2023-076272 A describes coupling two or four Josephson parametric oscillators, and varying the relative phase between pump signals supplied to them for parametric oscillation to thereby vary the coupling strength.

### SUMMARY

It is preferable that the strength of the interaction of a plurality of quantum bit elements can be adjusted with as high accuracy as possible.

An object of the present disclosure is to provide a quantum computing circuit and a coupler capable of solving the above-described problem.

According to a first aspect of the present disclosure, a quantum computing circuit includes quantum bit elements, and a coupler that causes equal to or more than two of the quantum bit elements to interact with each other, wherein the coupler includes a loop including a plurality of Josephson junctions, at least two of the Josephson junctions having different critical current values, and a magnetic field applying means for applying a magnetic field to the loop.

According to a second aspect of the present disclosure, a coupler includes a loop including a plurality of Josephson junctions, at least two of the Josephson junctions having different critical current values, and a magnetic field applying means for applying a magnetic field to the loop, wherein the coupler causes equal to or more than two quantum bit elements to interact.

According to the present disclosure, the strength of interaction of quantum bit elements can be adjusted with relatively high accuracy.

### BRIEF DESCRIPTION OF THE DRAWINGS

FIG. 1 is a diagram illustrating an example of a configuration of an information processing device according to at least one example embodiment;

FIG. 2 is a diagram illustrating an example of an implementation of many-body coupling in a quantum computing circuit according to at least one example embodiment;

FIG. 3 is a diagram illustrating an example of a relationship between the critical current value of a Josephson junction loop and the Kerr nonlinearity of a coupler;

FIG. 4 is a diagram illustrating examples of the relationships of the magnetic field applied to the Josephson junction loop with the resonance frequency and the Kerr nonlinearity of the coupler, respectively;

FIG. 5 is a diagram illustrating a first example of a configuration of a coupler according to at least one example embodiment;

FIG. 6 is a diagram illustrating a second example of a configuration of a coupler according to at least one example embodiment;

FIG. 7 is a diagram illustrating a third example of a configuration of a coupler according to at least one example embodiment;

FIG. 8 is a diagram illustrating an example of a configuration of a quantum computing circuit according to at least one example embodiment;

FIG. 9 is a diagram illustrating an example of a configuration of a coupler according to at least one example embodiment; and

FIG. 10 is a schematic block diagram illustrating a configuration of a computer according to at least one example embodiment.

### EXAMPLE EMBODIMENT

Hereinafter, example embodiments will be described with reference to the drawings.

### First Example Embodiment

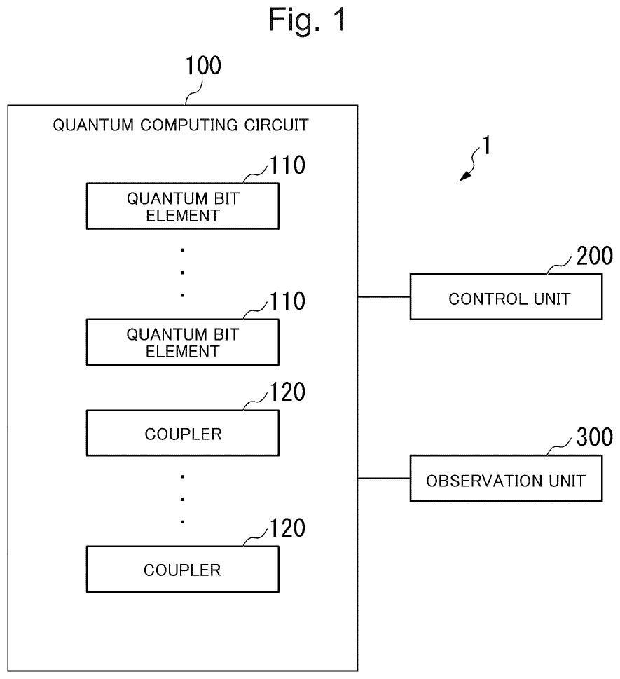

FIG. 1 is a diagram illustrating an example of a configuration of an information processing device according to at least one example embodiment. In the configuration illustrated in FIG. 1, an information processing device 1 includes a quantum computing circuit 100, a control unit 200, and an observation unit 300. The quantum computing circuit 100 includes quantum bit elements 110 and a coupler 120.

The information processing device 1 performs quantum computing. For example, the information processing device 1 may perform quantum annealing. The information processing device 1 can also be referred to as a quantum computer. In a case where the information processing device 1 performs quantum annealing, the information processing device can also be referred to as a quantum annealing machine.

The quantum computing circuit 100 executes quantum computing under the control of the control unit 200.

The quantum bit elements 110 are elements for representing quantum bit values. Each of the quantum bit elements 110 may be configured using a Josephson parametric oscillator (JPO), but they are not limited thereto.

The coupler 120 causes equal to or more than two quantum bit elements 110 to interact. The coupler 120 may cause equal to or more than three quantum bit elements 110 to undergo many-body interaction. As used herein, an interaction of the quantum bit elements 110 means that the quantum bit values represented by the quantum bit elements 110 are correlated. An interaction of the quantum bit elements 110 can also be referred to as an interaction between the quantum bit elements 110. An interaction of the quantum bit elements 110 can also be referred to as a quantum bit interaction or an interaction between quantum bits. The interaction of the quantum bit elements 110 can also be referred to as coupling of the quantum bit elements 110, coupling between the quantum bit elements 110, quantum bit coupling, or coupling between quantum bits.

The coupler 120 may be configured using, for example, a nonlinear coupler such as a Josephson parametric oscillator.

The control unit 200 controls the quantum computing circuit 100 to execute quantum computing. For example, depending on the problem to be solved by the quantum computing, such as a combinatorial optimization problem, the control unit 200 sets a parameter value used in the quantum computing, such as the strength of the many-body interaction of the quantum bit elements 110 by the coupler 120. Furthermore, the control unit 200 controls the state transitions of the quantum bit elements 110 (their quantum states) by, for example, varying the magnetic field input to the quantum bit elements 110 over time.

The observation unit 300 reads the quantum bit value as a result of the quantum computing. Specifically, when a predetermined time has elapsed from the start of quantum computing, the observation unit 300 observes the output signal of the quantum bit elements 110 to detect the quantum state.

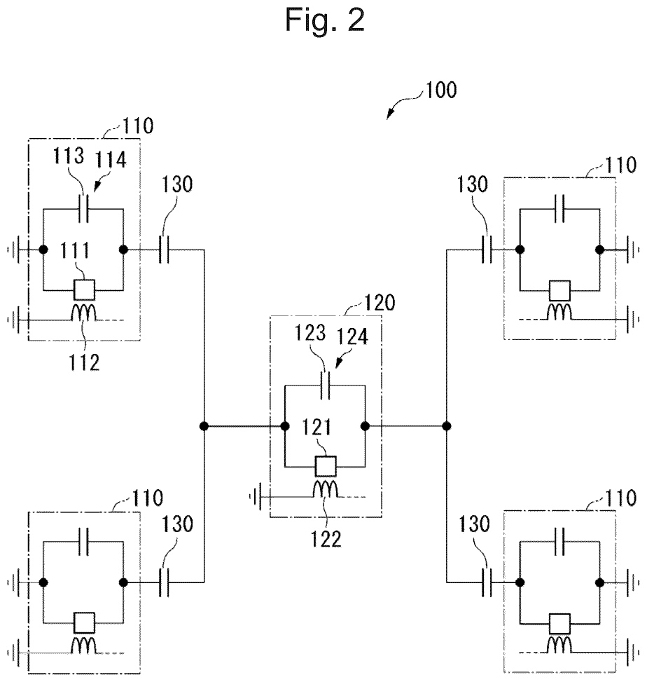

FIG. 2 is a diagram illustrating an example of an implementation of many-body coupling (many-body interaction) in the quantum computing circuit 100. FIG. 2 illustrates an example in the case of four-body coupling, in which four quantum bit elements 110 and one coupler 120 are connected. However, the number of quantum bit elements 110 caused to interact by the coupler 120 is not limited to four, and may be equal to or more than two.

The quantum bit elements 110 each include a Josephson junction loop 111, an inductor 112, and a capacitor 113. The Josephson junction loop 111 and the capacitor 113 are provided on a loop. The loop including the Josephson junction loop 111 and the capacitor 113 is also referred to as a resonator 114.

The loop being provided with a Josephson junction can also be referred to as the loop having a Josephson junction.

In the Josephson junction loop 111, a superconductor provided with a Josephson junction forms a loop (closed circuit). For example, but not by way of limitation, the Josephson junction loop 111 may be a superconducting quantum interference device (SQUID), which is a loop having two Josephson junctions.

The inductor 112 generates a magnetic field when a current flows through the inductor 112 itself, and applies the magnetic field to the Josephson junction loop 111. The inductor 112 applies a magnetic field to the Josephson junction loop 111 in such a manner that its strength can be varied, in such a way that the Josephson junction loop 111 can function as a variable inductor (inductor having a variable inductance).

The strength of the magnetic field can also be referred to as the magnitude of the magnetic field.

The capacitor 113 represents the capacitance of the resonator 114. A structural capacitor of the resonator 114 may function as the capacitor 113, or an element as the capacitor 113 may be provided. The capacitance of the capacitor 113 can also be regarded as the capacitance of the quantum bit element 110.

When the Josephson junction loop 111 functions as a variable inductor, the resonator 114 becomes a loop having a variable resonance frequency. As a result, the quantum bit element 110 can be operated as a parametric oscillator.

The resonance frequency of the resonator 114 can also be referred to as the resonance frequency of the coupler 120.

The coupler 120 includes a Josephson junction loop 121, an inductor 122, and a capacitor 123. The Josephson junction loop 121 and the capacitor 123 are provided on a loop. The loop including the Josephson junction loop 121 and the capacitor 123 is also referred to as a resonator 124.

In the Josephson junction loop 121, a superconductor provided with a Josephson junction forms a loop. For example, and without limitation, the Josephson junction loop 121 may be a SQUID. Various nonlinear elements can be used as the Josephson junction loop 121. Since the Josephson junction loop 121 is configured using a nonlinear element, equal to or more than three quantum bit elements 110 can interact with each other.

A Hamiltonian H of the linear resonator can be expressed by Formula (1) using capacitance C, inductance L, electric charge Q, and magnetic flux Φ.

$$[ Expression 1 ]$$

$$H = \frac{{Q}^{2}}{2 C} + \frac{{Φ}^{2}}{2 L} \qquad ( 1 )$$

On the other hand, the Hamiltonian of the nonlinear resonator includes a third-order or higher term of (D.

It is assumed that the Josephson junction loop 121 is provided with a plurality of asymmetric Josephson junctions. As used herein, a plurality of Josephson junctions being symmetric means that their critical current values are the same. A plurality of Josephson junctions being asymmetric means that there is a Josephson junction having a different critical current value from the other Josephson junctions. When equal to or more than three Josephson junctions are provided in the Josephson junction loop 121, the critical current values of all the Josephson junctions may be different from each other, or the critical current values of some of the Josephson junctions may be the same.

A Josephson junction loop including asymmetric Josephson junctions may also be referred to as an asymmetric Josephson junction loop.

The inductor 122 generates a magnetic field when a current flows through the inductor 122 itself, and applies the magnetic field to the Josephson junction loop 121. The inductor 122 applies a magnetic field to the Josephson junction loop 121 in such a manner that its strength can be varied, in such a way that the Josephson junction loop 121 can function as a variable inductor.

The inductor 122 corresponds to an example of a magnetic field applying means.

The capacitor 123 represents the capacitance of the resonator 124. A structural capacitor of the resonator 124 may function as the capacitor 123, or an element as the capacitor 123 may be provided. The capacitance indicated by the capacitor 123 can also be regarded as the capacitance of the coupler 120.

When the Josephson junction loop 121 functions as a variable inductor, the resonator 124 becomes a loop having a variable resonance frequency. By adjusting the resonance frequency of the coupler 120 to cause the coupler 120 to interact with each of the quantum bit elements 110, it is possible to cause the four quantum bit elements 110 to undergo four-body interaction. Since the inductance of the Josephson junction loop 121 is variable, the strength of interaction of the quantum bit elements 110 by the coupler 120 can be adjusted.

Here, the relationship between the Josephson junction loop of the coupler being asymmetric and the adjustment of the coupling strength of the quantum bit elements will be described.

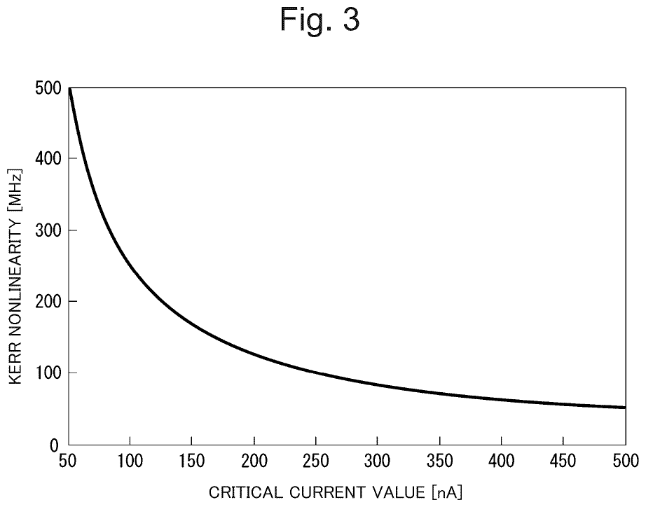

FIG. 3 is a diagram illustrating an example of a relationship between the critical current value of a Josephson junction loop and the Kerr nonlinearity of a coupler. FIG. 3 illustrates an example in which a four-body coupler includes a single-junction Josephson junction loop and the resonance frequency is 10 gigahertz (GHz). As used herein, a single-junction Josephson junction loop means that a single Josephson junction is provided in the Josephson junction loop.

The horizontal axis of the graph of FIG. 3 represents the critical current value. The vertical axis represents the strength of Kerr nonlinearity. The stronger the Kerr nonlinearity, the stronger the four-body interaction due to the coupler.

The strength of Kerr nonlinearity can also be referred to as the magnitude of Kerr nonlinearity. The strength of interaction can also be referred to as the magnitude of interaction.

In the example of FIG. 3, the smaller the critical current value, the stronger the Kerr nonlinearity.

The correlation that the smaller the critical current value, the stronger the interaction between the quantum bit elements is not limited to the case where the number of interacting quantum bit elements is four, or to the case where the number of Josephson junctions in the Josephson junction loop is one.

A resonance frequency f of the coupler is expressed by Formula (2).

$$[ Expression 2 ]$$

$$f = \frac{1}{2 π \sqrt{C ( L + {L}_{J} )}} \qquad ( 2 )$$

π represents the mathematical constant pi.

C represents the structural capacitance of the resonator (the loop including the Josephson junction loop and the capacitor). Here, the structural capacitance of the resonator is the capacitance of the resonator.

L_{J} represents the inductance of the Josephson junction loop.

L represents the structural inductance of the resonator. Here, the structural inductance of the resonator is the inductance of the resonator other than the inductance of the Josephson junction loop. Therefore, the sum L+L_{J} of the structural inductance L of the resonator and the inductance L_{J} of the Josephson junction loop indicates the inductance of the resonator.

As shown in Formula (2), the smaller the capacitance C, the larger the resonance frequency f. In a case where it is desired to enhance the interaction of the quantum bit elements by reducing the capacitance C, and to keep the resonance frequency f constant, it is necessary to increase at least one of the structural inductance L of the resonator and the inductance L_{J} of the Josephson junction loop.

Here, there is a correlation that the nonlinearity decreases (the nonlinearity becomes smaller) when the structural inductance L increases. As the nonlinearity decreases, the interaction strength of the quantum bit elements also decreases.

In a case where it is desired to increase the interaction strength of the quantum bit elements and to keep the resonance frequency f constant, it is conceivable to reduce the capacitance C and increase the inductance L_{J} of the Josephson junction loop.

The inductance L_{J} of the Josephson junction loop is proportional to the inverse of the critical current value of the Josephson junction. Therefore, in order to increase the inductance L_{J} of the Josephson junction loop, it is necessary to reduce the critical current value of the Josephson junction.

On the other hand, it is generally difficult to produce a Josephson junction having a small critical current value. In addition, in quantum bit elements, a Josephson junction having a relatively large critical current value of several hundred nanoamperes (nA) is often used. The quantum bit elements and the coupler can be efficiently manufactured by using the same type of Josephson junction in the coupler as in the quantum bit elements.

Therefore, a case is considered in which the resonance frequency is adjusted by applying a magnetic field to the Josephson junction loop. Specifically, a case is considered in which the coupler is fabricated using a Josephson junction having a critical current value comparable to that of the quantum bit elements, and a magnetic field is applied to the Josephson junction loop to reduce the resonance frequency.

In that case, when the resonance frequency is reduced by adjusting the applied magnetic field, the nonlinearity increases, and a stronger interaction can be obtained.

Here, when the coupler includes a Josephson junction loop provided with a plurality of symmetric Josephson junctions, adjusting the applied magnetic field reduces the resonance frequency to zero.

In a case where the resonance frequency decreases to 0, the gradient of the resonance frequency with respect to the magnetic field becomes steep compared to a case where the resonance frequency does not decrease to 0, and it may not be able to accurately adjust the resonance frequency.

Therefore, as described above, as the Josephson junction loop 121 of the coupler 120, a Josephson junction loop provided with a plurality of asymmetric Josephson junctions is used. In this case, the minimum value of the resonance frequency becomes larger than 0, and the gradient of the resonance frequency with respect to the magnetic field becomes relatively gentle. In particular, it is expected that the resonance frequency can be adjusted with relatively high accuracy using the range of resonance frequencies near the magnetic field that provides the minimum resonance frequency, in which range the gradient of the resonance frequency with respect to the magnetic field is relatively gentle and the interaction of the quantum bit elements is relatively strong. For example, it is expected that the resonance frequency can be kept approximately constant with respect to changes in the magnetic field due to factors such as noise, and resistance to magnetic field fluctuations can be provided.

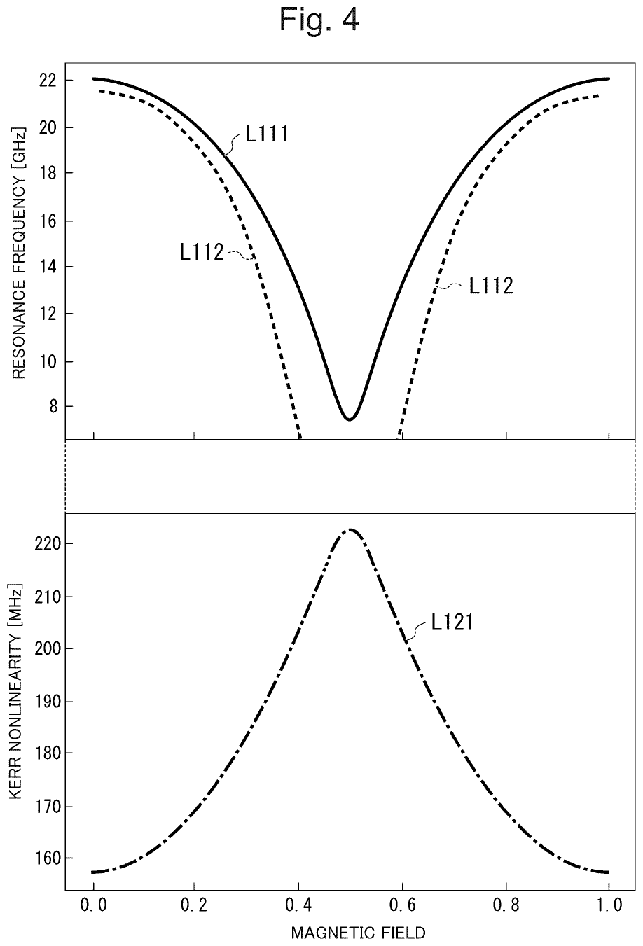

FIG. 4 is a diagram illustrating examples of the relationships of the magnetic field applied to the Josephson junction loop with the resonance frequency and the Kerr nonlinearity of the coupler, respectively. FIG. 4 illustrates an example of a case of a four-body coupler including a SQUID. The horizontal axis of the graph of FIG. 4 indicates the strength of the magnetic field, expressed as a value normalized using the magnetic flux quantum Φ₀. The vertical axes represent the resonance frequency and the strength of Kerr nonlinearity, respectively.

A line L111 shows an example of the relationship between the strength of the magnetic field and the resonance frequency in the case of an asymmetric SQUID.

A line L112 shows an example of the relationship between the strength of the magnetic field and the resonance frequency in the case of a symmetric SQUID.

A line L121 shows an example of the relationship between the strength of the magnetic field and the strength of the Kerr nonlinearity in the case of an asymmetric SQUID.

In the case of a symmetric SQUID, the minimum value of the resonance frequency is 0, and the slope of the resonance frequency relative to the magnetic field is relatively steep, as shown by the line L112.

In contrast, in the case of an asymmetric SQUID, the minimum value of the resonance frequency is greater than 0, and the slope of the resonance frequency relative to the magnetic field is relatively gentle, as shown by the line L111. Since the gradient of the resonance frequency with respect to the magnetic field is relatively gentle, it is expected that the resonance frequency can be adjusted with relatively high accuracy.

As indicated by the line L121, the strength of the Kerr nonlinearity is the greatest at the magnetic field strength at which the resonance frequency is the smallest (the strength of the Kerr nonlinearity is the greatest). By adjusting the strength of the magnetic field applied to the Josephson junction loop, the strength of the Kerr nonlinearity can be adjusted according to the resonance frequency. The smaller the resonance frequency, the stronger the Kerr nonlinearity, and when the gradient of the resonance frequency becomes gentle, the gradient of the Kerr nonlinearity also becomes gentle. According to the coupler 120, in this respect, it is expected that the Kerr nonlinearity can be adjusted with relatively high accuracy, whereby the interaction strength of the quantum bit elements 110 can be adjusted with relatively high accuracy.

In particular, the inductor 122 may apply a magnetic field of a variable strength to the Josephson junction loop 121 within a range that includes the strength at which the resonance frequency of the coupler 120 takes the minimum value. That is, the control unit 200 may adjust the strength of interaction of the quantum bit elements by the coupler 120 by using, as the current value flowing through the inductor 122, a current value that falls within a range including the current value at which the resonance frequency of the coupler 120 takes the minimum value.

As a result, the control unit 200 can adjust the strength of interaction within a range where the interaction caused by the coupler 120 is relatively strong.

Further, as illustrated in FIG. 4, in the vicinity of the magnetic field where the resonance frequency of the coupler 120 takes the minimum value, the gradient of the interaction strength with respect to the magnetic field strength is particularly gentle, and it is expected that the control unit 200 can adjust the interaction strength with relatively high accuracy.

The operation of the control unit 200 to adjust the strength of the interaction caused by the coupler 120 can also be regarded as an operation of the coupler 120 to adjust the strength of the interaction under the control by the control unit 200.

According to the coupler 120, it is expected that the interaction strength of the quantum bit elements 110 can be adjusted with relatively high accuracy not only in the case where the number of the Josephson junctions provided in the Josephson junction loop 121 is two but also in the case where the number of the Josephson junctions is equal to or more than three.

According to the coupler 120, it is expected that the interaction strength of the quantum bit elements 110 can be adjusted with relatively high accuracy not only when there are four interacting quantum bit elements 110, but also when there are 2 or 3, and equal to or more than 5 interacting quantum bit elements 110.

As described above, the Josephson junction loop 121 of the coupler 120 may be, but is not limited to, a SQUID.

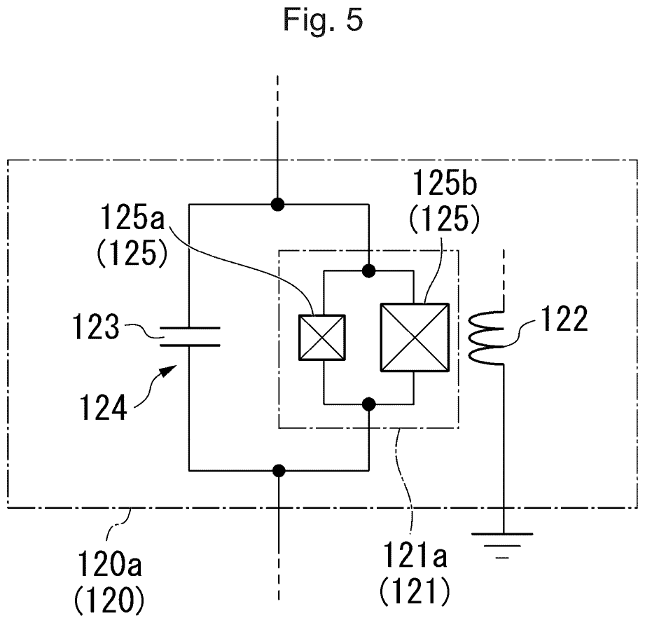

FIG. 5 is a diagram illustrating a first example of the configuration of the coupler 120. In the example of FIG. 5, the Josephson junction loop 121 is configured using an asymmetric SQUID. As described above, a SQUID is a loop having two Josephson junctions.

The Josephson junctions are also referred to as Josephson junctions 125. The two Josephson junctions in the example of FIG. 5 are also referred to as Josephson junction 125a and 125b. The Josephson junctions 125a and 125b are asymmetric. That is, the critical current values of the Josephson junction 125a and 125b are different from each other.

As in the example of FIG. 5, the Josephson junction loop 121 configured using the SQUID is also referred to as a Josephson junction loop 121a. The coupler 120 in which the Josephson junction loop 121 is configured using an asymmetric SQUID is also referred to as a coupler 120a.

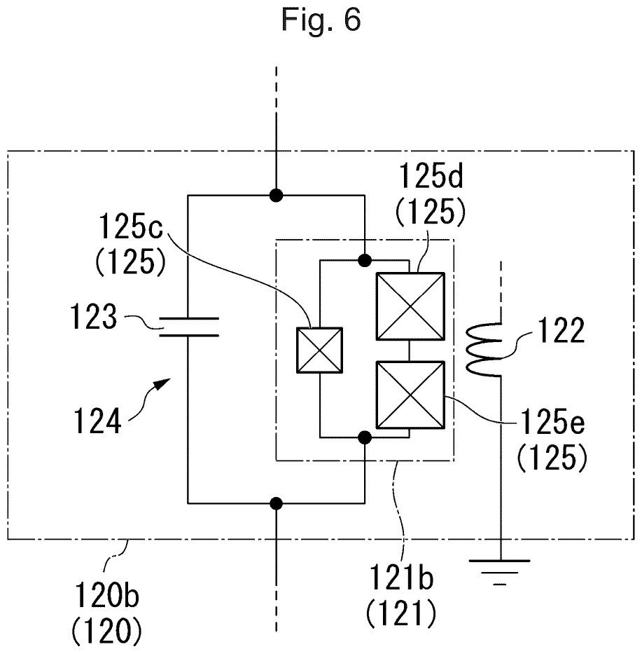

FIG. 6 is a diagram illustrating a second example of the configuration of the coupler 120. In the example of FIG. 6, the Josephson junction loop 121 is configured as a loop having equal to or more than three asymmetric Josephson junctions 125. FIG. 6 illustrates an example of a case where the Josephson junction loop 121 has three Josephson junctions 125. However, the Josephson junction loop 121 may have equal to or more than four Josephson junctions 125. In addition, the number of Josephson junctions on the left side of the Josephson junction loop 121 (the number of Josephson junctions in the column of a Josephson junctions 125c) in FIG. 6 is not limited to one, and a plurality of Josephson junctions may be provided.

The three Josephson junctions in the example of FIG. 6 are also referred to as Josephson junction 125c, 125d, and 125e. The Josephson junctions 125c, 125d, and 125e are asymmetric. That is, at least any two of the Josephson junctions 125c, 125d, and 125e have different critical current values. All critical current values of the Josephson junctions 125c, 125d and 125e may be different from one another.

A Josephson junction loop 121 including equal to or more than three asymmetric Josephson junctions 125, as in the example of FIG. 6, is also referred to as a Josephson junction loop 121b. A coupler 120 including a Josephson junction loop 121 with equal to or more than three asymmetric Josephson junctions 125 is also referred to as a coupler 120b.

Similarly, when the Josephson junction loop 121b includes equal to or more than four Josephson junctions 125, it suffices if at least one of the Josephson junctions 125 has a critical current value different from the critical current values of the other Josephson junctions 125.

Here, in a case where the Josephson junction loop 121 is configured using a SQUID, an additional operation such as application of a signal is required to cause an odd number of quantum bit elements 110 to interact, such as three-body interaction or five-body interaction. On the other hand, since the Josephson junction loop 121 is configured as a loop having equal to or more than three Josephson junctions, it is expected that an odd number of quantum bit elements 110 can interact with relatively high accuracy without the need to perform an additional operation.

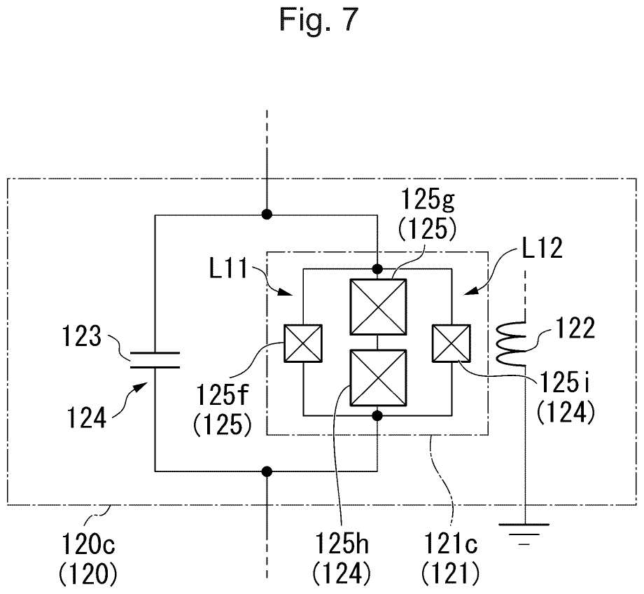

FIG. 7 is a diagram illustrating a third example of the configuration of the coupler 120. In the example of FIG. 7, the Josephson junction loop 121 is configured using a combination of two loops. The two loops are also referred to as loops L11 and L12.

Also, in the example of FIG. 7, the Josephson junction loop 121 has four asymmetric Josephson junctions 125. The four Josephson junctions 125 are also referred to as Josephson junctions 125f, 125g, 125h, and 125i.

Among the four Josephson junctions 125, the Josephson junction 125f is included only in the loop L11 and not in the loop L12. The Josephson junctions 125g and 125h are Josephson junctions 125 shared by the loops L11 and L12. That is, the Josephson junctions 125g and 125h are included in both the loops L11 and L12. The Josephson junction 125i is included only in the loop L12 and not in the loop L11.

The Josephson junction 125f, 125g, 125h, and 125i are asymmetric. That is, at least any two of the Josephson junctions 125f, 125g, 125h, and 125i have different critical current values. All critical current values of the Josephson junctions 125f, 125g, 125h, and 125i may be different from one another.

However, the Josephson junction loop 121 may include equal to or more than three loops. The number of the Josephson junctions 125 included in the Josephson junction loop 121 including a plurality of loops is not limited to a specific number. It suffices if, for each loop, there is a Josephson junction 125 included only in that loop and a Josephson junction 125 shared by a plurality of loops.

As in the example of FIG. 7, a Josephson junction loop 121 in which a plurality of asymmetric Josephson junctions 125 are provided in a plurality of loops is also referred to as a Josephson junction loop 121c. A coupler 120 including a Josephson junction loop 121 in which a plurality of asymmetric Josephson junctions 125 are provided in a plurality of loops is also referred to as a coupler 120c.

Similarly, when the Josephson junction loop 121c includes equal to or more than four Josephson junctions 125, it suffices if at least one of the Josephson junctions 125 has a critical current value different from the critical current values of the other Josephson junctions 125.

Since the Josephson junction loop 121 is configured as a loop having equal to or more than three Josephson junctions, it is expected that an odd number of quantum bit elements 110 can interact with relatively high accuracy. In addition, since the Josephson junction loop 121 is configured using a combination of a plurality of loops, the magnetic field applied to the loops can be adjusted loop-by-loop, and it is expected that the interaction of the quantum bit elements 110 can be executed with relatively high accuracy.

As in the examples of FIGS. 6 and 7, since the Josephson junction loop 121 is configured as a loop having equal to or more than three Josephson junctions 125, it is expected that an odd number of quantum bit elements 110 can interact with relatively high accuracy without the need to perform an additional operation.

On the other hand, in the region in which the gradient of the resonance frequency with respect to the strength of the magnetic field is relatively gentle described with reference to FIGS. 3 and 4, when the sharpness of the graph of the portion in which the resonance frequency is minimized is high, the width of the region becomes small, and when the sharpness is low, the width of the region becomes large. When the number of the Josephson junctions 125 in the Josephson junction loop 121 is equal to or more than three, the sharpness of the graph is higher than that in the case of two.

Therefore, as in the example of FIG. 5, when the number of the Josephson junctions 125 included in the Josephson junction loop 121 is two, the gradient of the resonance frequency with respect to the strength of the magnetic field becomes gentle as compared with the case where the number of the Josephson junctions 125 included in the Josephson junction loop 121 is equal to or more than three. In a case where the number of the Josephson junctions 125 included in the Josephson junction loop 121 is two, it is expected that the resonance frequency can be adjusted with relatively high accuracy in this respect.

In addition, in a case where the number of the Josephson junctions 125 included in the Josephson junction loop 121 is two, the gradient of the strength of the interaction of the quantum bit elements 110 with respect to the strength of the magnetic field is also gentle as compared with a case where the number of the Josephson junctions 125 included in the Josephson junction loop 121 is equal to or more than three. In a case where the number of the Josephson junctions 125 included in the Josephson junction loop 121 is two, it is expected that the strength of the interaction of the quantum bit elements 110 can be adjusted with relatively high accuracy in this respect.

As described above, the Josephson junction loop 121 includes a plurality of Josephson junctions 125, at least two of which have different critical current values.

The inductor 122 applies a magnetic field to the Josephson junction loop 121.

The coupler 120 causes equal to or more than two quantum bit elements to interact.

In the quantum computing circuit 100, the minimum value of the resonance frequency of the coupler 120 becomes larger than 0, and the gradient of the resonance frequency with respect to the magnetic field becomes relatively gentle. According to the quantum computing circuit 100, in this respect, it is expected that the resonance frequency of the coupler 120 can be adjusted with relatively high accuracy, whereby the strength of the interaction of the quantum bit elements by the coupler 120 can be adjusted with relatively high accuracy.

In addition, the inductor 122 applies, to the Josephson junction loop 121, a magnetic field having a strength close to the strength at which the resonance frequency of the coupler 120 takes the minimum value.

For example, when the resonance frequency f is a function f(Φ) of the magnetic field strength Φ (strength normalized by the magnetic flux quantum Φ₀), the value of Φ is preferably set in a range in which the second-order differential coefficient of f takes a positive value, that is, in a range represented by Formula (3) or d²f/dΦ²>0.

$$[ Expression 3 ]$$

$$\frac{{d}^{2} f}{d {Φ}^{2}} > 0 \qquad ( 3 )$$

This can also be rephrased as follows.

The value of f satisfying Formula (4) is denoted as f₁.

$$[ Expression 4 ]$$

$$\frac{{d}^{2} f}{d {Φ}^{2}} = 0 \qquad ( 4 )$$

In FIG. 4, the points at which Formula (4) holds are inflection points of the graph. There are two values of Φ corresponding to the inflection points in this case: one smaller and one greater than the value of Φ corresponding to the minimum resonance frequency fₘᵢₙ (on the left and right sides of the graph, respectively). When these values are denoted as Φ₁ₐ and Φ_{1b}, it is preferable that the magnetic field strength Φ applied to the Josephson junction loop 121 is set to a value within a range indicated by Formula (5).

$$[ Expression 5 ]$$

$${Φ}_{1 a} < Φ < {Φ}_{1 b} \qquad ( 5 )$$

An intermediate value (midpoint value or average value) between f₁ and fₘᵢₙ is represented by f₂. That is, it can be expressed by Formula (6).

$$[ Expression 6 ]$$

$${f}_{2} = \frac{{f}_{1} + {f}_{min}}{2} \qquad ( 6 )$$

Similarly to the values of Φ corresponding to f₁ (i.e., similarly to the inflection points), there are two values of Φ corresponding to f₂: one smaller and one greater than the value of Φ corresponding to the minimum resonance frequency fₘᵢₙ (on the left and right sides of the graph, respectively). When these values are denoted as Φ₂ₐ and Φ_{2b}, it is further preferable that the magnetic field strength (applied to the Josephson junction loop 121 is set to a value within a range indicated by Formula (7).

$$[ Expression 7 ]$$

$${Φ}_{2 a} < Φ < {Φ}_{2 b} \qquad ( 7 )$$

Furthermore, an intermediate value (midpoint value or average value) between f₂ and fₘᵢₙ is represented by f₃. That is, it can be expressed by Formula (8).

$$[ Expression 8 ]$$

$${f}_{3} = \frac{{f}_{2} + {f}_{min}}{2} \qquad ( 8 )$$

Similarly to the values of Φ corresponding to f₂, there are two values of Φ corresponding to f₃: one smaller and one greater than the value of Φ corresponding to the minimum resonance frequency fₘᵢₙ (on the left and right sides of the graph, respectively). When these values are denoted as Φ₃a and Φ_{3b}, it is further preferable that the magnetic field strength Φ applied to the Josephson junction loop 121 is set to a value within a range indicated by Formula (9).

$$[ Expression 9 ]$$

$${Φ}_{3 a} < Φ < {Φ}_{3 b} \qquad ( 9 )$$

According to the quantum computing circuit 100, the interaction strength can be adjusted within a range in which the interaction of the quantum bit elements 110 is relatively strong.

In addition, according to the quantum computing circuit 100, the interaction strength can be adjusted within a range in which the gradient of the interaction strength with respect to the magnetic field strength is relatively gentle, and in this respect, it is expected that the interaction strength can be adjusted with relatively high accuracy.

In addition, two Josephson junctions having different critical current values are provided in the Josephson junction loop 121.

According to the quantum computing circuit 100, the gradient of the resonance frequency with respect to the strength of the magnetic field becomes gentle as compared with the case where the number of the Josephson junctions 125 included in the Josephson junction loop 121 is equal to or more than three. According to the quantum computing circuit 100, in this respect, it is expected that the resonance frequency can be adjusted with relatively high accuracy.

In addition, according to the quantum computing circuit 100, the gradient of the interaction strength of the quantum bit elements 110 with respect to the magnetic field strength becomes gentle as compared with the case where the number of the Josephson junctions 125 included in the Josephson junction loop 121 is equal to or more than three. According to the quantum computing circuit 100, in this respect, it is expected that the interaction strength of the quantum bit elements 110 can be adjusted with relatively high accuracy.

In addition, the Josephson junction loop 121 includes equal to or more than three Josephson junctions 115, at least two of which have different critical current values.

According to the quantum computing circuit 100, it is expected an odd number of quantum bit elements 110 can interact with relatively high accuracy.

### Second Example Embodiment

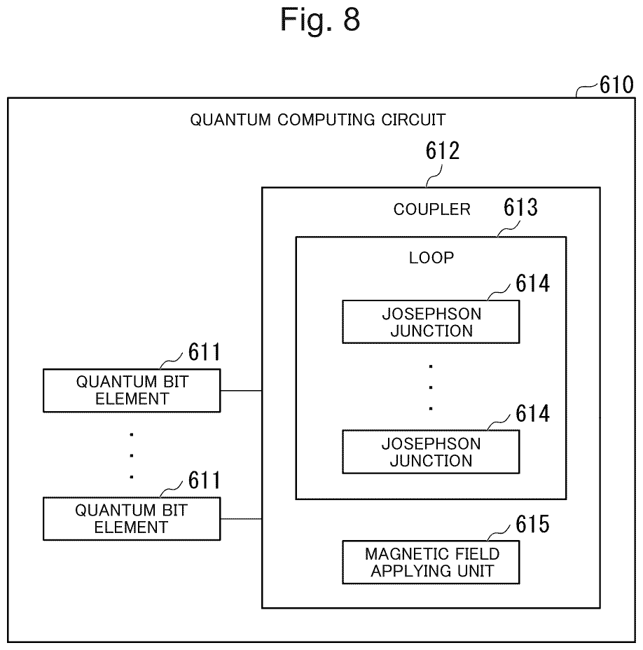

FIG. 8 is a diagram illustrating an example of a configuration of a quantum computing circuit according to at least one example embodiment. In the configuration illustrated in FIG. 8, a quantum computing circuit 610 includes quantum bit elements 611 and a coupler 612. The coupler 612 includes a loop 613 and a magnetic field applying unit 615. The loop 613 is provided with a plurality of Josephson junctions 614.

The coupler 612 causes equal to or more than two quantum bit elements 611 to interact.

The critical current values of at least two of the Josephson junctions 614 are different from each other.

The magnetic field applying unit 615 applies a magnetic field to the loop 613.

The magnetic field applying unit 615 corresponds to an example of the magnetic field applying means.

In the quantum computing circuit 610, the minimum value of the resonance frequency of the coupler 612 becomes larger than 0, and the gradient of the resonance frequency with respect to the magnetic field becomes relatively gentle. According to the quantum computing circuit 610, in this respect, it is expected that the resonance frequency of the coupler 612 can be adjusted with relatively high accuracy, whereby the strength of the interaction of the quantum bit elements by the coupler 612 can be adjusted with relatively high accuracy.

### Third Example Embodiment

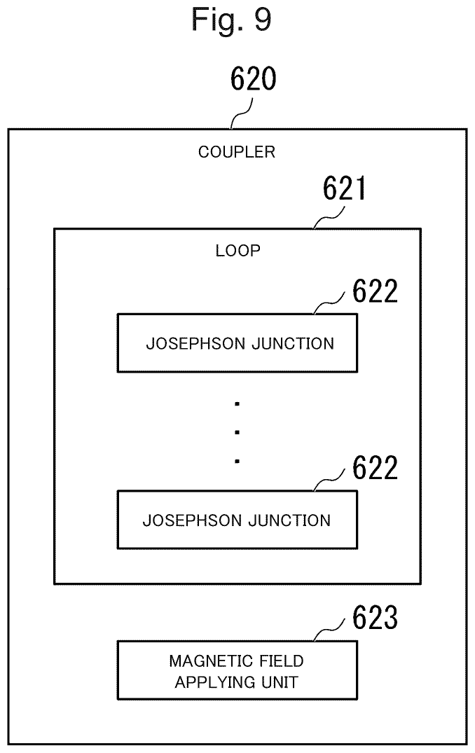

FIG. 9 is a diagram illustrating an example of a configuration of a coupler according to at least one example embodiment. In the configuration illustrated in FIG. 9, the coupler 620 includes a loop 621 and a magnetic field applying unit 623. The loop 621 is provided with a plurality of Josephson junctions 622.

The critical current values of at least two of the Josephson junctions 622 are different from each other.

The magnetic field applying unit 623 applies a magnetic field to the loop 621.

The coupler 620 causes equal to or more than two quantum bit elements to interact.

The magnetic field applying unit 623 corresponds to an example of the magnetic field applying means.

In the coupler 620, the minimum value of the resonance frequency becomes larger than 0, and the gradient of the resonance frequency with respect to the magnetic field becomes relatively gentle. According to the coupler 620, in this respect, it is expected that the resonance frequency can be adjusted with relatively high accuracy, whereby the strength of the interaction of the quantum bit elements by the coupler 620 can be adjusted with relatively high accuracy.

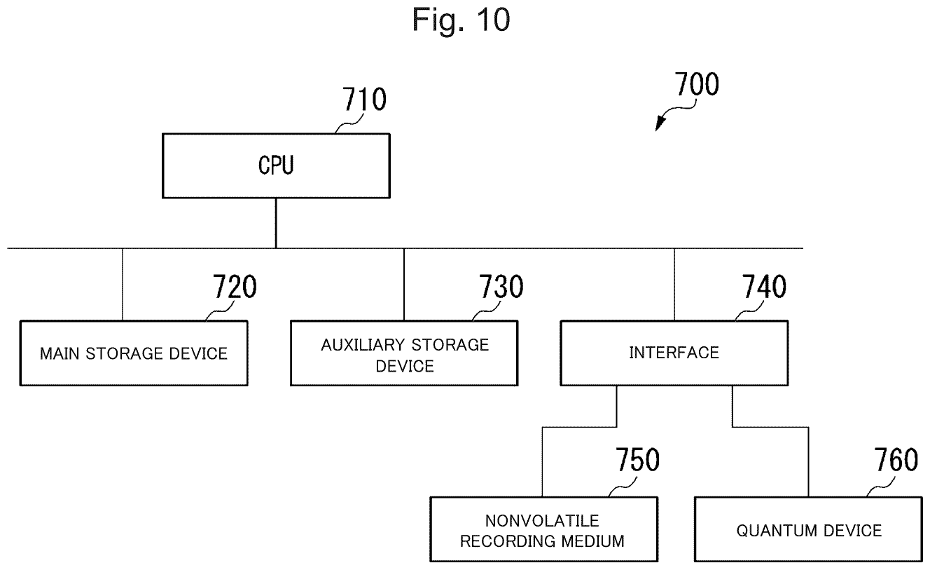

FIG. 10 is a schematic block diagram illustrating a configuration of a computer according to at least one example embodiment.

In the configuration illustrated in FIG. 10, a computer 700 includes a CPU 710, a main storage device 720, an auxiliary storage device 730, an interface 740, a nonvolatile recording medium 750, and a quantum device 760.

The information processing device 1 or part thereof may be implemented in the computer 700. In that case, the quantum computing circuit 100 may be used as the quantum device 760. Then, the operations of the control unit 200 and the observation unit 300 may be stored in the auxiliary storage device 730 in the form of a program. The CPU 710 reads the program from the auxiliary storage device 730, loads the program in the main storage device 720, and executes the above processing according to the program. The CPU 710 secures a storage area for the control unit 200 and the observation unit 300 to perform processing in the main storage device 720 according to the program.

In addition, the interface 740 outputs control signals to the quantum device 760 and reads signals output from the quantum device 760 under the control of the CPU 710.

The interface 740 has a port for the nonvolatile recording medium 750, and reads information from the nonvolatile recording medium 750 and writes information to the nonvolatile recording medium 750.

Communication between the information processing device 1 and the other devices is executed by the interface 740 having a communication function and performing communication under control by the CPU 710. The interaction between the information processing device 1 and the user is executed when the interface 740 includes an input device and an output device, information is presented to the user by the output device according to the control of the CPU 710, and a user operation is received by the input device.

Any one or more of the above-described programs may be recorded in the nonvolatile recording medium 750. In this case, the interface 740 may read the program from the nonvolatile recording medium 750. The CPU 710 may directly execute the program read by the interface 740, or may temporarily store the program in the main storage device 720 or the auxiliary storage device 730 and execute the program.

A program for executing all or a part of the processing performed by the control unit 200 and the observation unit 300 may be recorded in a computer-readable recording medium, and the processing of each unit may be performed by causing a computer system to read and execute the program recorded in the recording medium. The “computer system” herein includes an operating system (OS) and hardware such as peripheral devices.

The “computer-readable recording medium” refers to a portable medium such as a flexible disk, a magneto-optical disk, a read only memory (ROM), and a compact disc read only memory (CD-ROM), and a storage device such as a hard disk built in a computer system. The program may be for implementing some of the functions described above, and the functions described above may be implemented in combination with a program already recorded in the computer system.

While the present disclosure has been particularly shown and described with reference to example embodiments thereof, the present disclosure is not limited to these example embodiments. It will be understood by those of ordinary skill in the art that various changes in form and details may be made therein without departing from the spirit and scope of the present disclosure as defined by the claims. And each example embodiment can be appropriately combined with other example embodiments.

The whole or part of the example embodiments disclosed above can be described as, but not limited to, the following supplementary notes.

### (Supplementary Note 1)

A quantum computing circuit including:
quantum bit elements; and a coupler that causes equal to or more than two of the quantum bit elements to interact with each other,
wherein the coupler includes
a loop including a plurality of Josephson junctions, at least two of the Josephson junctions having different critical current values, and
a magnetic field applying means for applying a magnetic field to the loop.

### (Supplementary Note 2)

The quantum computing circuit according to Supplementary Note 1,
wherein the magnetic field applying means applies, to the loop, a magnetic field having a strength close to the strength at which the resonance frequency of the coupler takes a minimum value.

### (Supplementary Note 3)

The quantum computing circuit according to Supplementary Note 1 or 2,
wherein the loop includes two Josephson junctions having different critical current values.

### (Supplementary Note 4)

The quantum computing circuit according to Supplementary Note 1 or 2,
wherein the loop includes equal to or more than three Josephson junctions, and at least two of the Josephson junctions have different critical current values.

### (Supplementary Note 5)

A coupler including:
a loop including a plurality of Josephson junctions, at least two of the Josephson junctions having different critical current values; and
a magnetic field applying means for applying a magnetic field to the loop,
wherein the coupler causes equal to or more than two quantum bit elements to interact.

### (Supplementary Note 6)

The coupler according to Supplementary Note 5,
wherein the magnetic field applying means applies, to the loop, a magnetic field having a strength close to the strength at which the resonance frequency of the coupler takes a minimum value.

### (Supplementary Note 7)

The coupler according to Supplementary Note 5 or 6,
wherein the loop includes two Josephson junctions having different critical current values.

### (Supplementary Note 8)

The coupler according to Supplementary Note 5 or 6,
wherein the loop includes equal to or more than three Josephson junctions, and at least two of the Josephson junctions have different critical current values.

1. A quantum computing circuit comprising:
quantum bit elements; and a coupler that causes equal to or more than two of the quantum bit elements to interact with each other,
wherein the coupler includes
a loop including a plurality of Josephson junctions, at least two of the Josephson junctions having different critical current values, and
a magnetic field applicator configured to apply a magnetic field to the loop.

2. The quantum computing circuit according to claim 1,
wherein a resonance frequency of the coupler is indicated as a function of a strength of the magnetic field, and
the magnetic field applicator applies, to the loop, a magnetic field having a strength in a range in which a second-order differential coefficient of the resonance frequency takes a positive value.

3. The quantum computing circuit according to claim 1,
wherein the loop includes two Josephson junctions having different critical current values.

4. The quantum computing circuit according to claim 1,
wherein the loop includes equal to or more than three Josephson junctions, and at least two of the Josephson junctions have different critical current values.

5. The quantum computing circuit according to claim 2,
wherein the loop includes two Josephson junctions having different critical current values.

6. The quantum computing circuit according to claim 2,
wherein the loop includes equal to or more than three Josephson junctions, and at least two of the Josephson junctions have different critical current values.

7. A coupler comprising:
a loop including a plurality of Josephson junctions, at least two of the Josephson junctions having different critical current values; and
a magnetic field applicator configured to apply a magnetic field to the loop,
wherein the coupler causes equal to or more than two quantum bit elements to interact.
